(19) United States
(12) Patent Application Publication
(10) Pub. No.: US 2024/0174948 A1
(43) Pub. Date: May 30, 2024

(54) AQUEOUS SOLUTIONS FOR CLEANING GLASS ARTICLES AND METHODS OF USING SUCH

(71) Applicant: CORNING INCORPORATED, CORNING, NY (US)

(72) Inventors: Yuhui Jin, Painted Post, NY (US); Aize Li, Painted Post, NY (US); Hamidreza Pirayesh, San Diego, CA (US)

(21) Appl. No.: 18/519,165

(22) Filed: Nov. 27, 2023

Related U.S. Application Data
(60) Provisional application No. 63/428,456, filed on Nov. 29, 2022.

(51) Int. Cl. C11D 11/00; C11D 1/62; C11D 3/04

(52) U.S. Cl. CPC C11D 11/0035; C11D 1/62; C11D 3/046

(57) ABSTRACT

According to embodiments of the present disclosure, an aqueous solution for cleaning glass articles may include, water; at least one of hydrochloric acid, nitric acid, phosphoric acid, an organic acid, and combinations thereof; and at least one of: a positively charged surfactant, and a metal salt. The aqueous solution may include from 0.01 wt. % to 1 wt. % of the positively charged surfactant, based on the total weight of the aqueous solution. A concentration of the metal salt in the aqueous solution may be from 0.1 M to 1 M. The aqueous solution may has a pH from 0 to 4.

This application claims the benefit of priority U.S. Provisional Application Ser. No. 63/428,456 filed on Nov. 29, 2022, the content of which is relied upon and incorporated herein by reference in its entirety.

### BACKGROUND

### Field

The present specification generally relates to aqueous solutions and, more specifically, to aqueous solutions that are useful for cleaning glass articles.

### Technical Background

Glass cleaning accompanies many steps during glass finishing in glass manufacturing processes. For example, without limitation, glass articles may be cleaned after they are cut and glass articles may be cleaned after they are polished. Conventional cleaning solutions may include acid and may have a pH from 1-3. However, some glass articles are not durable in such acid solutions. The use of conventional acid cleaning solutions on such glass articles may result in the glass articles being etched, and the etching may result in optical defects in the glass articles, such as a color shift in the glass article. For example, the etching may impart a blue hue to some glass articles.

Accordingly, a need exists for aqueous solutions and methods for cleaning glass articles using the aqueous solutions that reduce the rate of the formation of optical defects in the glass articles, such as color shift, while cleaning the glass articles. This need and other needs are addressed by the present disclosure.

### SUMMARY

According to a first aspect of the present disclosure, an aqueous solution for cleaning glass articles comprises, water; at least one of hydrochloric acid, nitric acid, phosphoric acid, an organic acid, and combinations thereof; and at least one of: a positively charged surfactant, wherein the aqueous solution comprises from 0.01 wt. % to 1 wt. % of the positively charged surfactant, based on the total weight of the aqueous solution; and a metal salt, wherein a concentration of the metal salt is from 0.1 M to 1 M; wherein the aqueous solution has a pH from 0 to 4.

A second aspect of the present disclosure may include the first aspect, wherein the aqueous solution comprises the positively charged surfactant.

A third aspect of the present disclosure may include the second aspect, wherein the positively charged surfactant comprises a quaternary ammonium cation.

A fourth aspect of the present disclosure may include the second aspect or the third aspect, wherein the positively charged surfactant has a molecular weight from 10,000 Da to 400,000 Da.

A fifth aspect of the present disclosure may include any of the second through fourth aspects, wherein the surfactant comprises an anion selected from Cl⁻ and Br⁻.

A sixth aspect of the present disclosure may include any of the second through fifth aspects, wherein the positively charged surfactant comprises poly(diallyl dimethylammonium chloride), cetyltrimethylamonium bromide, or a combination thereof.

A seventh aspect of the present disclosure may include any of the first through sixth aspects, wherein the aqueous solution comprises the metal salt.

An eighth aspect of the present disclosure may include the seventh aspect, wherein the metal salt comprises a metal cation having a +1 charge.

A ninth aspect of the present disclosure may include the seventh aspect or the eighth aspect, wherein the metal salt comprises LiCl, NaCl, CsCL, KCl, KNO₃, or a combination thereof.

A tenth aspect of the present disclosure may include any of the first through ninth aspects, wherein the aqueous solution comprises an organic acid.

An eleventh aspect of the present disclosure may include the tenth aspect, wherein the organic acid comprises citric acid, acetic acid, oxalic acid, or combinations thereof.

A twelfth aspect of the present disclosure may include any of the first through eleventh aspects, wherein the aqueous solution comprises from 3 wt. % to 0.03 wt. % hydrochloric acid.

A thirteenth aspect of the present disclosure may include any of the first through twelfth aspects, wherein the aqueous solution comprises from 0.1 wt. % to 5 wt. % citric acid.

A fourteenth aspect of the present disclosure may include any of the first through thirteenth aspects, wherein a concentration of H₃O⁺ in the aqueous solution is from 0.0001 M to 1 M.

A fifteenth aspect of the present disclosure may include any of the first through fourteenth aspects, wherein the pH of the aqueous solution is from 1 to 4.

According to a sixteenth aspect of the present disclosure, a method for cleaning a glass article comprises contacting a glass article with an aqueous solution to form a cleaned glass article, the aqueous solution comprising: water; at least one of hydrochloric acid, nitric acid, phosphoric acid, an organic acid, and combinations thereof; and at least one of: a positively charged surfactant, wherein the aqueous solution comprises from 0.01 wt. % to 1 wt. % of the positively charged surfactant, based on the total weight of the aqueous solution; and a metal salt, wherein a concentration of the metal salt is from 0.1 M to 1 M; wherein the aqueous solution has a pH from 0 to 4.

A seventeenth aspect of the present disclosure may include the sixteenth aspect, wherein contacting the glass article with the aqueous solution occurs at a temperature from 20° C. to 70° C.

An eighteenth aspect of the present disclosure may include the sixteenth aspect or the seventeenth aspect, wherein contacting the glass article with the aqueous solution occurs for a time from 0.5 min. to 30 min.

A nineteenth aspect of the present disclosure may include any of the sixteenth through eighteenth aspects, wherein the glass article comprises from 45 mol. % to 70 mol. % SiO₂, from 15 mol. % to 25 mol. % Al₂O₃, from 0 mol. % to 6 mol. % B₂O₃, from 0 mol. % to 5 mol. % P₂O₅, from 0 mol. % to 10 mol. % LiO₂, from 5 mol. % to 15 mol. % Na₂O, from 0 mol. % to 1 mol. % K₂O, from 0 mol. % to 5 mol. % MgO, from 0 mol. % to 1 mol. % TiO₂, and from 0 mol. % to 1 mol. % SnO₂.

A twentieth aspect of the present disclosure may include any of the sixteenth through nineteenth aspects, wherein a color shift of the cleaned glass article is less than or equal to 1.

A twenty-first aspect of the present disclosure may include any of the sixteenth through twentieth aspects, wherein a haze of the cleaned glass article is less than or equal to 0.03%.

A twenty-second aspect of the present disclosure may include any of the sixteenth through twenty-first aspects, wherein the method comprises an initial step of contacting the glass article with CeO₂ particles, wherein contacting the glass article with the CeO₂ particles polishes at least a portion of the glass article.

A twenty-third aspect of the present disclosure may include the twenty-second aspect, wherein the CeO₂ particles have a particle size from 0.6 μm to 3 μm.

A twenty-fourth aspect of the present disclosure may include the twenty-second aspect or the twenty-third aspect, wherein a surface of the cleaned glass article is substantially free from the CeO₂ particles.

A twenty-fifth aspect of the present disclosure may include any of the sixteenth through twenty-fourth aspects, wherein the method further comprises contacting the cleaned glass article with a basic solution, the basic solution having a pH from 10 to 14.

A twenty-sixth aspect of the present disclosure may include the twenty-fifth aspect, wherein the basic solution comprises KOH, NaOH, or combinations thereof.

A twenty-seventh aspect of the present disclosure may include the twenty-fifth aspect or the twenty-sixth aspect, wherein the cleaned glass article is contacted with the basic solution for a time from 2 min. to 12 min.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, serve to explain the principles and operations of the claimed subject matter.

### BRIEF DESCRIPTION OF THE DRAWINGS

FIG. 1 depicts the measured haze of glass articles treated with aqueous solutions over time according to embodiments of Example 4;

FIG. 2 depicts measured color shifts of polished glass articles according to embodiments of Example 5;

FIG. 3A depicts a scanning electron microscopy (SEM) image of a surface of a polished glass article according to an embodiment of Example 5;

FIG. 3B depicts a SEM image of a surface of a polished glass article according to an embodiment of Example 5;

FIG. 3C depicts a SEM image of a surface of a polished glass article according to an embodiment of Example 5;

FIG. 3D depicts a SEM image of a surface of a polished glass article according to an embodiment of Example 5;

FIG. 4A depicts a SEM image of a surface of a polished glass article according to an embodiment of Example 5;

FIG. 4B depicts a SEM image of a surface of a polished glass article according to an embodiment of Example 5;

FIG. 4C depicts a SEM image of a surface of a polished glass article according to an embodiment of Example 5;

FIG. 4D depicts a SEM image of a surface of a polished glass article according to an embodiment of Example 5;

FIG. 5A depicts a SEM image of a surface of a polished glass article according to an embodiment of Example 5;

FIG. 5B depicts an energy-dispersive x-ray (EDX) spectrum of a particle on a surface of a polished glass article according to an embodiment of Example 5;

FIG. 5C depicts an EDX spectrum of a particle on a surface of a polished glass article according to an embodiment of Example 5; and

FIG. 5D depicts an EDX spectrum of a particle on a surface of a polished glass article according to an embodiment of Example 5.

### DETAILED DESCRIPTION

Reference will now be made in detail to various embodiments of aqueous solutions for cleaning glass articles and methods for using such aqueous solutions to clean glass articles. Whenever possible, the same reference numerals will be used throughout the drawings to refer to the same or like parts. In embodiments, an aqueous solution for cleaning glass articles may comprise water, at least one of hydrochloric acid, nitric acid, phosphoric acid, an organic acid, and combinations thereof, and at least one of a positively charged surfactant and a metal salt. Embodiments, of the aqueous solution may be used in a method for cleaning a glass article, where the method comprises contacting a glass article with the aqueous solution. Embodiments of the aqueous solutions and methods for using such are described in further detail herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the singular forms “a,” “an” and “the” include plural referents unless the context clearly dictates otherwise. Thus, for example, reference to “a” component includes aspects having two or more such components, unless the context clearly indicates otherwise.

Glass articles may be cleaned using an aqueous solution comprising an acid during finishing of the glass articles. Conventional aqueous solutions may etch glass articles that are less resistant to acid. This etching may impart optical defects to the glass articles, such as a color shift. Accordingly, a need exists for aqueous solutions that may be used to clean glass articles that are less durable in acid solutions. Embodiments of aqueous solutions described herein may be suitable for cleaning glass articles that may be etched in conventional acidic cleaning solutions. Without intending to be bound by theory, the inclusion of a positively charged surfactant, a metal salt, or both in the aqueous solution may reduce the rate of glass dissolution in the aqueous solution. This in turn may reduce the formation of optical defects in the glass articles.

In embodiments, the aqueous solution may comprise water. For example, without limitation, the water may include one or more of deionized water, tap water, distilled water, or fresh water. In embodiments, one or more constituents of the aqueous solution may be dissolved in the water.

In embodiments, the aqueous solution may comprise at least one of hydrochloric acid, nitric acid, phosphoric acid, an organic acid, and combinations thereof. In embodiments, the organic acid may comprise citric acid, acetic acid, oxalic acid, or combinations thereof. In embodiments, the aqueous solution may comprise more than one acid. For example, the aqueous solution may comprise 2, 3, 4, 5, or more acids.

In embodiments, a pH of the aqueous solution may be from 0 to 4. For example, without limitation, the pH of the aqueous solution may be from 0 to 4, from 0.5 to 4, from 1 to 4, from 1.5 to 4, from 2 to 4, from 2.5 to 4, from 3 to 4, from 3.5 to 4, from 0 to 3.5, from 0 to 3, from 0 to 2.5, from 0 to 2, from 0 to 1.5, from 0 to 1, from 0 to 0.5 or any sub-range formed from any of these endpoints. In embodiments, a concentration of the hydronium ion (H₃O⁺) in the aqueous solution may be from 0.0001 molar (M) to 1 M. For example, without limitation, a concentration of H₃O⁺ in the aqueous solution may be from 0.0001 M to 1 M, from 0.001 M to 1 M, from 0.01 M to 1 M, from 0.1 M to 1 M, from 0.5 M to 1 M, from 0.0001 M to 0.5 M, from 0.0001 M to 0.1 M, from 0.0001 M to 0.01 M, from 0.0001 M to 0.001 M, or any sub-range formed from any of these endpoints.

In embodiments, the aqueous solution may comprise from 0.03 wt. % to 3 wt. % hydrochloric acid. For example, without limitation, the aqueous solution may comprise hydrochloric acid from 0.03 wt. % to 3 wt. %, from 0.05 wt. % to 3 wt. %, from 0.1 wt. % to 3 wt. %, from 0.5 wt. % to 3 wt. %, from 1 wt. % to 3 wt. %, from 1.5 wt. % to 3 wt. %, from 2 wt. % to 3 wt. %, from 2.5 wt. % to 3 wt. %, from 0.03 wt. % to 2.5 wt. %, from 0.03 wt. % to 2 wt. %, from 0.03 wt. % to 1.5 wt. %, from 0.03 wt. % to 1 wt. %, from 0.03 wt. % to 0.5 wt. %, from 0.03 wt. % to 0.1 wt. %, from 0.03 wt. % to 0.05 wt. %, or any sub-range formed from any of these endpoints.

In embodiments, the aqueous solution may comprise from 0.1 wt. % to 5 wt. % citric acid. For example, without limitation the aqueous solution may comprise citric acid from 0.1 wt. % to 5 wt. %, from 0.5 wt. % to 5 wt. %, from 1 wt. % to 5 wt. %, 1.5 wt. % to 5 wt. %, from 2 wt. % to 5 wt. %, from 2.5 wt. % to 5 wt. %, from 3 wt. % to 5 wt. %, from 3.5 wt. % to 5 wt. %, from 4 wt. % to 5 wt. %, from 4.5 wt. % to 5 wt. %, from 0.1 wt. % to 4.5 wt. %, from 0.1 wt. % to 4 wt. %, from 0.1 wt. % to 3.5 wt. %, from 0.1 wt. % to 3 wt. %, from 0.1 wt. % to 2.5 wt. %, from 0.1 wt. % to 2 wt. %, from 0.1 wt. % to 1.5 wt. %, from 0.1 wt. % to 1 wt. %, from 0.1 wt. % to 1.5 wt. %, or any sub-range formed from any of these endpoints.

Without intending to be bound by theory, the acid content of the aqueous solution may be sufficient to clean a glass article when the glass article is contacted with the aqueous solution. However, when a glass article is exposed to the aqueous solution, portions of the glass article may dissolve in the aqueous solution. For example, when the glass article is exposed to an acid, ion exchange between metal ions in the glass article and hydronium ions (H₃O⁺) or hydrogen ions (H⁺), or both, in the solution may create stress in Si—O bonds on the surface of the glass article. Water may attack Si—O bonds that are in tension on the surface of the glass article, which may result in the dissolution of portions of the glass article and the formation of a porous structure on the surface of the glass article. Air may penetrate into the porous structure, which may lower the surface refractive index of the glass article, causing a color shift. As the pore size increases, the surface of the glass article may become rough and may scatter light, causing an increase in haze of the glass article. Without intending to be bound by theory, including a positively charged surfactant, or a metal salt, or both, in the aqueous solution may reduce the rate of glass dissolution in the acid. In turn, this may reduce the color shift and haze imparted to a glass article that is contacted with the aqueous solution.

In embodiments, the aqueous solution may comprise a positively charged surfactant. The positively charged surfactant may comprise a quaternary ammonium cation. In embodiments, the positively charged surfactant may comprise an anion selected from Cl⁻ and Br⁻. For example, without limitation, the positively charged surfactant may comprise poly(diallyl dimethylammonium chloride), cetyltrimethylamonium bromide, or a combination thereof. In embodiments, the positively charged surfactant may consist of poly(diallyl dimethylammonium chloride), or cetyltrimethylamonium bromide, or a combination thereof.

In embodiments, the positively charged surfactant may have a molecular weight from 10,000 Da to 400,000 Da. For example, without limitation, the positively charged surfactant may have a molecular weight from 10,000 Da to 400,000 Da, from 50,000 Da to 400,000 Da, from 100,000 Da to 400,000 Da, from 150,000 Da to 400,000 Da, from 200,000 Da to 400,000 Da, from 250,000 Da to 400,000 Da, from 300,000 Da to 400,000 Da, from 350,000 Da to 400,000 Da, from 10,000 Da to 350,000 Da, from 10,000 Da to 300,000 Da, from 10,000 Da to 250,000 Da, from 10,000 Da to 200,000 Da, from 10,000 Da to 150,000 Da, from 10,000 Da to 100,000 Da, from 10,000 Da to 50,000 Da, or any sub-range formed from any of these endpoints.

In embodiments, the aqueous solution may comprise from 0.01 wt. % to 1 wt. % of the positively charged surfactant based on the total weight of the aqueous solution. For example, without limitation, the aqueous solution may comprise the positively charged surfactant in an amount from 0.01 wt. % to 1 wt. %, from 0.05 wt. % to 1 wt. %, from 0.1 wt. % to 1 wt. %, from 0.2 wt. % to 1 wt. %, from 0.3 wt. % to 1 wt. %, from 0.4 wt. % to 1 wt. %, from 0.5 wt. % to 1 wt. %, from 0.6 wt. % to 1 wt. %, from 0.7 wt. % to 1 wt. %, from 0.8 wt. % to 1 wt. %, from 0.9 wt. % to 1 wt. %, from 0.01 wt. % to 0.9 wt. %, from 0.01 wt. % to 0.8 wt. %, from 0.01 wt. % to 0.7 wt. %, from 0.01 wt. % to 0.6 wt. %, from 0.01 wt. % to 0.5 wt. %, from 0.01 wt. % to 0.4 wt. %, from 0.01 wt. % to 0.3 wt. %, from 0.01 wt. % to 0.2 wt. %, from 0.01 wt. % to 0.1 wt. %, from 0.01 wt. % to 0.05 wt. %, or any sub-range formed from any of these endpoints.

Without intending to be bound by theory, including a positively charged surfactant in the aqueous solution may reduce the rate of glass dissolution when a glass article is contacted with the aqueous solution. The positively charged surfactant may compete with the H₃O⁺ and H⁺ ions in the aqueous solution in the exchange with mobile ions in the glass article. This may reduce the ion exchange rate and the dissolution rate of the glass article. Additionally, the positively charged surfactant may attach to the negatively charged surface of the glass article by electrostatic interaction. This may form a protective layer over a surface of the glass article. The protective layer may also reduce the dissolution of the glass article in the aqueous solution. As described above, reducing the rate of dissolution of the glass article in the aqueous solution may reduce color shift and haze imparted to the glass article when the glass article is contacted with the aqueous solution.

In embodiments, the aqueous solution may comprise a metal salt. The metal salt may comprise a metal cation having a +1 charge. For example, without limitation, the metal salt may comprise a Li⁺, Na⁺, K⁺, or Cs⁺ cation. It should be understood that the cation of the metal salt is not necessarily limited to alkali metals. It is contemplated that any metal ion having a +1 charge may be a suitable cation for the metal salt. The anion for the metal salt is not necessarily limited. In embodiments, the metal salt may comprise any suitable anion. For example, without limitation, the anion may comprise Cl⁻, Br⁻, NO₃⁻, or any other suitable anion.

In embodiments, the metal salt may comprise LiCl, NaCl, CsCl, KCl, KNO₃, or a combination thereof. In embodiments, the metal salt may consist of LiCl, or NaCl, or CsCl, or KCl, or KNO₃, or a combination thereof.

In embodiments, the concentration of the metal salt in the aqueous solution may be from 0.1 M to 1 M. For example, without limitation, the concentration of the metal salt in the aqueous solution may be from 0.1 M to 1 M, from 0.2 M to 1 M, from 0.3 M to 1 M, from 0.4 M to 1 M, from 0.5 M to 1 M, from 0.6 M to 1 M, from 0.7 M to 1 M, from 0.8 M to 1 M, from 0.9 M to 1 M, from 0.1 M to 0.9 M, from 0.1 M to 0.8 M, from 0.1 M to 0.7 M, from 0.1 M to 0.6 M, from 0.1 M to 0.5 M, from 0.1 M to 0.4 M, from 0.1 M to 0.3 M, from 0.1 M to 0.2 M, or any sub-range formed from any of these endpoints.

Without intending to be bound by theory, including a metal salt in the aqueous solution may reduce a concentration gradient of metals between the glass article and the aqueous solution. This may reduce the rate of ion exchange between metal ions in the glass article with the H₃O⁺ and H⁺ ions in the aqueous solution, which may reduce the rate of dissolution of the glass article. Reducing the rate of dissolution of the glass article may reduce the formation of optical defects, such as color shift, in the glass article.

In embodiments, the aqueous solution may comprise both a positively charged surfactant and a metal salt as described in the present disclosure. For example, without limitation, the aqueous solution may comprise both from 0.01 wt. % to 1 wt. % of the positively charged surfactant and the metal salt at a concentration from 0.1 M to 1 M, as described in the present disclosure.

The aqueous solutions may be used to clean glass articles. In embodiments, methods for cleaning glass articles may comprise contacting a glass article with the aqueous solution to form a cleaned glass article.

In embodiments, the glass article may comprise from 45 mol. % to 70 mol. % SiO₂. For example, without limitation, the glass article may comprise SiO₂ in an amount from 45 mol. % to 70 mol. %, from 50 mol. % to 70 mol. %, from 55 mol. % to 70 mol. % from 60 mol. % to 70 mol. %, from 65 mol. % to 70 mol. %, from 45 mol. % to 65 mol. %, from 45 mol. % to 60 mol. %, from 45 mol. % to 55 mol. %, from 45 mol. % to 50 mol. %, or any sub-range formed from any of these endpoints. In embodiments, the glass article may comprise from 15 mol. % to 25 mol. % Al₂O₃. In embodiments, the glass article may comprise from 0 mol. % to 6 mol. % B₂O₃. In embodiments, the glass article may comprise from 0 mol. % to 5 mol. % P₂O₅. In embodiments, the glass article may comprise from 0 mol. % to 10 mol. % LiO₂. In embodiments, the glass article may comprise from 5 mol. % to 15 mol. % Na₂O. In embodiments, the glass article may comprise from 0 mol. % to 1 mol. % K₂O. In embodiments, the glass article may comprise from 0 mol. % to 5 mol. % MgO. In embodiments, the glass article may comprise from 0 mol. % to 1 mol. % TiO₂. In embodiments, the glass article may comprise from 0 mol. % to 1 mol. % SnO₂. In embodiments, suitable glass articles may include, for example and without limitation, glasses manufactured and sold by Corning Incorporated under the Corning® Gorilla® Glass brand.

In embodiments, contacting the glass article with the aqueous solution may occur at a temperature from 20° ° C. to 70° C. (i.e., the temperature of the aqueous solution may be 20° C. to 70° C.). For example, without limitation, contacting the glass article with the aqueous solution may occur at a temperature from 20° C. to 70° C., from 30° ° C. to 70° C., from 40° C. to 70° C., from 50° C. to 70° C., from 60° ° C. to 70° C., from 20° C. to 60° C., from 20° C. to 50° C., from 20° C. to 40° C., from 20° ° C. to 30° C., or any sub-range formed from any of these endpoints. Without intending to be bound by theory, increasing the temperature at which the glass article is contacted with the aqueous solution may increase the rate at which the glass article is cleaned. However, if the temperature at which the glass article is contacted with the aqueous solution is increased too much, for example, without limitation, to a temperature over 70° ° C., the rate of dissolution of the glass article may increase and result in the formation of optical defects in the glass article.

In embodiments, contacting the glass article with the aqueous solution may occur for a time from 0.5 min. to 30 min. For example without limitation, contacting the glass article with the aqueous solution may occur for a time from 0.5 min. to 30 min., from 1 min. to 30 min., from 5 min. to 30 min., from 10 min. to 30 min., from 15 min. to 30 min., from 20 min. to 30 min., from 25 min. to 30 min., from 0.5 min. to 25 min., from 0.5 min. to 20 min., from 0.5 min. to 15 min., from 0.5 min. to 10 min., from 0.5 min. to 5 min., from 0.5 min. to 1 min., or any sub-range formed from any of these endpoints.

Contacting the glass article with the aqueous solution to form a cleaned glass article may result in a color shift of the clean glass article. In embodiments, the color shift of the clean glass article may be less than or equal to 1. For example, the color shift of the clean glass article may be less than or equal to 1, less than or equal to 0.9, less than or equal to 0.8, less than or equal to 0.7, less than or equal to 0.6, less than or equal to 0.5, less than or equal to 0.4, less than or equal to 0.3, less than or equal to 0.2, or even less than or equal to 0.1. As described herein, color shift may be measured using an X-Rite spectrophotometer. The color of a glass article may be measured before contacting the glass article with the aqueous solution and the color of a cleaned glass article may be measured after contacting with the aqueous solution. The X-Rite spectrophotometer may represent color using the color coordinates a, b, and L*. Color shift may be calculated using the formula given in Equation 1:

Color Shift=\sqrt{(a−a₀)²+(b−b₀)²+(L*−L*₀)²}

In Equation 1, a, b, and L* correspond to the color coordinates of the glass article, before the glass article is contacted with the aqueous solution, and a₀, b₀ and L*₀ correspond to the color coordinates of the cleaned glass article, after the cleaned glass article has been contacted with the aqueous solution.

In embodiments, the cleaned glass article may have a haze of less than or equal to 0.03%. For example, without limitation, the cleaned glass articles may have a haze of less than or equal to 0.03%, less than or equal to 0.025%, less than or equal to 0.02%, less than or equal to 0.015%, less than or equal to 0.01%, or even less than or equal to 0.005%. As described herein, haze may be measured by an X-Rite spectrophotometer set to transmission haze mode. Without intending to be bound by theory, a haze of 0.1% may be visible to the human eye and a haze of 0.03% may be significantly less visible. It is contemplated that cleaned glass articles having a haze of less than or equal to 0.03% may not have a haze that is visible to the human eye.

Methods for cleaning glass articles may be performed on glass articles that have been polished. Polishing glass articles may include contacting the glass articles with cerium oxide (CeO₂) particles. In embodiments, methods for cleaning glass articles described herein may include a preliminary step of contacting the glass article with CeO₂ particles, wherein contacting the glass article with the CeO₂ particles may polish at least a portion of the glass article. In embodiments, the glass articles may be contacted with a slurry comprising CeO₂ particles as part of a chemical-mechanical polishing process. In embodiments, a chemical-mechanical polishing process may comprise contacting the glass article with the slurry and a polishing pad. Without intending to be bound by theory, the polishing pad may contact the glass article at various pressures and rotational speeds in conjunction with the particles in the slurry to mechanically polish of the glass article. Additionally, the slurry may be basic and may slightly etch the surface of the glass article to chemically polish the surface of the glass article. It should be noted that any suitable chemical-mechanical polishing process may be used to polish the glass articles.

In embodiments, the CeO₂ particles may have a particle size from 0.6 μm to 3 μm. For example, without limitation, the CeO₂ particles may have a particle size from 0.6 μm to 3 μm, from 1 μm to 3 μm, from 1.5 μm to 3 μm, from 2 μm to 3 μm, from 2.5 μm to 3 μm, from 0.6 μm to 2.5 μm, from 0.6 μm to 2 μm, from 0.6 μm to 1.5 μm, from 0.6 μm to 1 μm, or any sub-range formed from any of these endpoints. Without intending to be bound by theory, polishing a glass article by contacting the glass article with CeO₂ particles may result in some CeO₂ particles remaining on the surfaces of the glass article. These CeO₂ particles may be removed by contacting the glass article with an acidic solution, such as the aqueous solutions previously described. However, if the particle size of the CeO₂ particles is too small, for example, less than 0.6 μm, then it may be difficult to remove CeO₂ particles that remain on the surface of the glass article using the aqueous solutions described herein.

In embodiments, cleaning the surface of the glass article using the aqueous solutions described herein may remove CeO₂ particles from the surface of the glass article. In embodiments, the surface of a cleaned glass article may be substantially free from CeO₂ particles. In embodiments, CeO₂ particles on the surface of a glass article may be detected by scanning electron microscopy (SEM) and energy-dispersive x-ray (EDX) spectroscopy. Without intending to be bound by theory, CeO₂ particles that are not removed from the surface of the glass article may affect the optical properties of the glass article and may impart a color shift or haze to the glass articles. Accordingly, it may be advantageous to remove CeO₂ particles from the surface of a glass article by contacting the glass articles with the aqueous solutions described herein.

In embodiments, methods for cleaning glass articles may further comprise contacting the cleaned glass article with a basic solution. The basic solution may comprise water and any suitable base. For example, without limitation, the basic solution may comprise KOH, NaOH, or combinations thereof. In embodiments, the basic solution may comprise a commercially available basic solution, such as but not limited to, Semiclean KG detergent.

In embodiments, the basic solution may have a pH from 10 to 14. For example, without limitation, the basic solution may have a pH from 10 to 14, from 10.5 to 14, from 11 to 14, from 11.5 to 14, from 12 to 14, from 12.5 to 14, from 13 to 14, from 13.5 to 14, from 10 to 13.5, from 10 to 13, from 10 to 12.5, from 10 to 12, from 10 to 11.5, from 10 to 11, from 10 to 10.5, or any sub-range formed from any of these endpoints.

In embodiments, the cleaned glass article may be contacted with the basic solution for a time from 2 min. to 12 min. For example, without limitation, the cleaned glass article may be contacted with the basic solution for a time from 2 min. to 12 min., from 3 min. to 12 min., from 4 min. to 12 min., from 5 min. to 12 min., from 6 min. to 12 min., from 7 min. to 12 min., from 8 min. to 12 min., from 9 min. to 12 min., from 10 min. to 12 min., from 11 min. to 12 min., from 2 min. to 11 min., from 2 min. to 10 min., from 2 min. to 9 min., from 2 min. to 8 min., from 2 min. to 7 min., from 2 min. to 6 min., from 2 min. to 5 min., from 2 min. to 4 min., from 2 min. to 3 min., or any sub-range formed from any of these endpoints.

In embodiments, the cleaned glass article may be contacted with the basic solution at a temperature from 20° ° C. to 70° C. (i.e., the temperature of the basic solution is from 20° C. to 70° C.). For example, without limitation the cleaned glass article may be contacted with the basic solution at a temperature from 20° ° C. to 70° C., from 30° ° C. to 70° C., from 40° C. to 70° C., from 50° ° C. to 70° C., from 60° ° C. to 70° C., from 20° C. to 60° C., from 20° C. to 50° C., from 20° C. to 40° C., from 20° C. to 30° C., or any sub-range formed from any of these endpoints.

Without intending to be bound by theory, contacting the cleaned glass article with a basic solution after contacting the glass article with the aqueous solution may rinse any residual aqueous solution from the cleaned glass article and may neutralize any residual acid remaining on the surface of the cleaned glass article. This may prevent further dissolution of the glass article and may reduce the likelihood of optical imperfections being imparted to the glass article. Additionally, contacting the cleaned glass article with the basic solution may remove material from the surface of the cleaned glass article into which a color shift may have been imparted by the aqueous solution. Accordingly, contacting the cleaned glass article with a basic solution may remove optical defects imparted to the glass article during contact with the aqueous solution.

### EXAMPLES

The embodiments described herein will be further clarified by the following examples.

### Example 1—Glass Article Dissolution in Aqueous Solutions

The reduction in mass of glass articles after being contacted with aqueous cleaning solutions was measured as described herein.

The mass of a first sample of Corning® Gorilla® Glass 7 was measured using a 5-digit balance. The first sample was contacted with a comparative aqueous solution comprising 1.5 wt. % citric acid for 5 min. at a temperature of 60° C. The mass of the first sample was measured again using the 5-digit balance, and the reduction in mass of the first sample was calculated. The change in mass of the first sample was 4.5 mg.

The mass of a second sample of Corning® Gorilla® Glass 7 was measured using the 5-digit balance. The second sample was contacted with a first aqueous solution comprising 1.5 wt. % citric acid and 0.1 wt. % PDADMAC for 5 min. at a temperature of 60° C. The mass of the second sample was measured again using the 5-digit balance, and the reduction in mass of the second sample was calculated. The change in mass of the second sample was 1.2 mg. The inclusion of 0.1 wt. % PDADMAC in the first aqueous solution reduced the change in mass of the second glass sample by 74% relative to the first glass sample.

The mass of a third sample of Corning® Gorilla® Glass 7 was measured using the 5-digit balance. The third sample was contacted with a second aqueous solution comprising 1.5 wt. % citric acid and 1 M KCl for 5 min. at a temperature of 60° ° C. The mass of the third sample was measured again using the 5-digit balance, and the reduction in mass of the third sample was calculated. The change in mass of the third sample was 0.5 mg. The inclusion of 1 M KCl in the second aqueous solution reduced the change in mass of the third glass sample by 88% relative to the first glass sample.

### Example 2—Glass Article Color Shift

The color shift of glass articles after being contacting with aqueous cleaning solutions was measured as described herein.

The color shift of the first glass sample of Example 1, the second glass sample of Example 1, and the third glass sample of Example 1 were each measured. The colors of the first glass sample of Example 1, the second glass sample of Example 1, and the third glass sample of Example 1 were measured using an X-Rite spectrophotometer before and after contacting the samples with the aqueous solutions. Then the color shift of each sample was calculated using Equation 1, as previously described. The color shifts of each of the first, second, and third glass samples of Example 1 are included in Table 1.

A fourth sample of Corning® Gorilla® Glass 7 was contacted with the comparative aqueous solution of Example 1 for 5 min. at a temperature of 60° C. Then the fourth sample was contacted with a 4 wt. % solution of Semiclean for 10 min. at a temperature of 60° C. with sonication. The color shift of the fourth glass sample was measure and the color shift is included in Table 1.

A fifth sample of Corning® Gorilla® Glass 7 was contacted with the first aqueous solution of Example 1 for 5 min. at a temperature of 60° C. Then the fifth sample was contacted with a 4 wt. % solution of Semiclean for 10 min. at a temperature of 60° C. with sonication. The color shift of the fifth glass sample was measure and the color shift is included in Table 1.

A sixth sample of Corning® Gorilla® Glass 7 was contacted with the second aqueous solution of Example 1 for 5 min. at a temperature of 60° C. Then the sixth sample was contacted with a 4 wt. % solution of Semiclean for 10 min. at a temperature of 60° C. with sonication. The color shift of the sixth glass sample was measure and the color shift is included in Table 1.

TABLE 1

| | Aqueous Solution | | | | Semiclean | Color |
|---|---|---|---|---|---|---|
| Sample | Citric Acid | PDADMAC | | KCl | Solution | Shift |
| 1 | 1.5 wt. % | 0 | wt. % | 0M | NA | 1.5 |
| 2 | 1.5 wt. % | 0.1 | wt. % | 0M | NA | 0.9 |
| 3 | 1.5 wt. % | 0 | wt. % | 1M | NA | 0.8 |
| 4 | 1.5 wt. % | 0 | wt. % | 0M | 4 wt. % | 0.6 |
| 5 | 1.5 wt. % | 0.1 | wt. % | 0M | 4 wt. % | 0.5 |
| 6 | 1.5 wt. % | 0 | wt. % | 1M | 4 wt. % | 0.06 |

As shown in Table 1, contacting the glass articles with aqueous solutions including a positively charged surfactant or a metal salt resulted in less color shift in the glass articles. Additionally, contacting the glass articles with the Semiclean solution after contacting them with the aqueous solutions further reduced the color shift of the glass articles.

### Example 3—Glass Article Color Shift as a Function of Metal Salt Concentration

The color shift of glass articles after being contacted with aqueous cleaning solutions with varying amounts of a metal salt were measured as described herein.

Samples of Corning® Gorilla® Glass 7 were contacted with four aqueous solutions. Each aqueous solution included 1.5 wt. % citric acid. The four aqueous solutions comprised 1 M KCl, 0.5 M KCl, 0.1 M KCl, and 0.05 M KCl respectively. Each sample was contacted with an aqueous solution at a temperature of 55° C. for a time of 2 min. The color shift of the samples contacted with the aqueous solutions were measured, as previously described. The color shift information is included in Table 2.

Samples of the Corning® Gorilla® Glass 7 that were contacted with each of the four aqueous solutions were contacted with a 4 wt. % solution of Semiclean for 10 min. at a temperature of 60° C. with sonication. The color shift of each of the samples that were contacted with both the aqueous solution and the Semiclean solution were measured. The color shift information is included in Table 2.

TABLE 2

| | | |
|---|---|---|
| Aqueous Solution | Semiclean | Color |

| Sample | Citric Acid | KCl | Solution | Shift |
|---|---|---|---|---|
| 7 | 1.5 wt. % | 1M | NA | 0.13 |
| 8 | 1.5 wt. % | 1M | 4 wt. % | 0.04 |
| 9 | 1.5 wt. % | 0.5M | NA | 0.32 |
| 10 | 1.5 wt. % | 0.5M | 4 wt. % | 0.08 |
| 11 | 1.5 wt. % | 0.1M | NA | 0.47 |
| 12 | 1.5 wt. % | 0.1M | 4 wt. % | 0.47 |
| 13 | 1.5 wt. % | 0.05M | NA | 0.36 |
| 14 | 1.5 wt. % | 0.05M | 4 wt. % | 0.47 |

As shown in Table 2, as the concentration of KCl in the aqueous solution increased, the color shift of the glass articles decreased. Additionally, when the concentration of KCl was 1 M or 0.5 M, contacting the glass articles with the Semiclean solution further reduced the color shift of the glass articles.

### Example 4—Effectiveness of Aqueous Solutions Comprising Metal Salts with Varying Cation Charge

The effect of metal salts comprising cations of varying charge in the aqueous solution was measured as described herein.

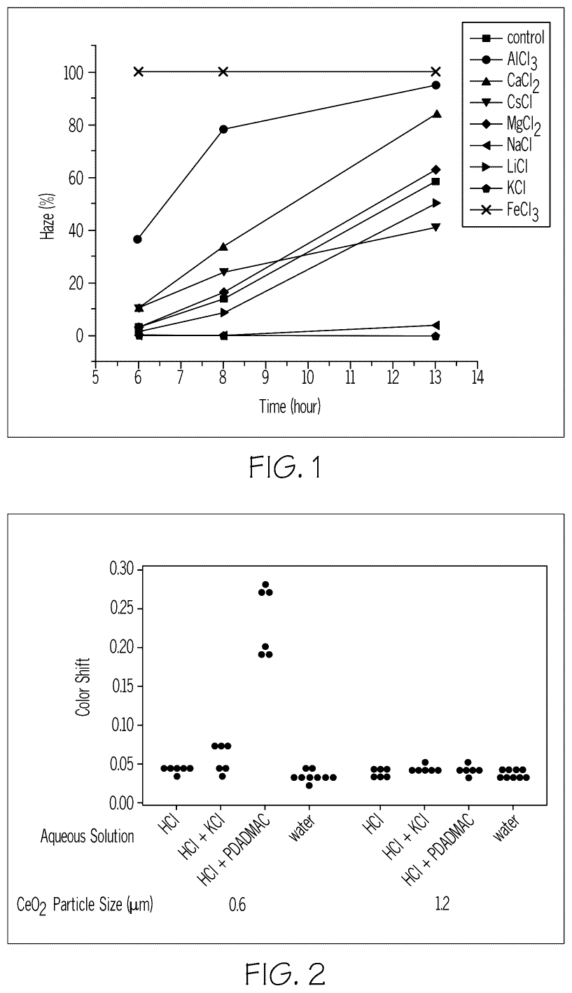

Glass articles were contacted with aqueous solutions for 13 hours at 95° C. The composition of the glass articles is given in Table 3. Each aqueous solution comprised 20 wt. % citric acid. Aqueous solutions included metal salts where the metal cation had a charge of +1, +2, or +3. The metal salts tested were AlCl₃, CaCl₂, CsCl, MgCl₂, NaCl, LiCl, KCl, and FeCl₃. The concentration of the metal salt in each aqueous solution was 1M. Additionally, a control aqueous solution including no metal salt was tested. The haze of the glass sample was measured using an X-Rite spectrophotometer at a time of 6 hours, 8 hours, and 13 hours. The haze data for each of the aqueous solutions is included in FIG. 1.

TABLE 3

| Component | (wt %) |
|---|---|
| SiO₂ (diff) | 52.71 |
| B₂O₃ (ICP) | 4.39 |
| Al₂O₃ | 27.22 |
| P₂O₅ | 3.12 |
| LiO₂ (ICP) | 3.44 |
| Na₂O | 8.08 |
| K₂O | 0.1 |
| MgO | 0.72 |
| TiO₂ | 0.12 |
| SnO₂ | 0.1 |

As shown in FIG. 1, the haze values of the glass articles treated with the aqueous solutions including metal salts having a metal cation with a +3 charge were greater than the haze value of the glass article treated with the control aqueous solution, which included no metal salt. Likewise, the haze values of the glass articles treated with the aqueous solutions including metal salts having a metal cation with a +2 charge were greater than the haze value of the glass article treated with the control aqueous solution. The haze values of the glass articles treated with aqueous solutions including metal salts having a metal cation with a +1 charge were less than the haze value of the glass article treated with the control aqueous solution when measured at a time of 13 hours.

### Example 5—Using Aqueous Solutions to Clean Polished Glass Articles

A first set of samples of Corning® Gorilla® Glass 7 were polished with a slurry comprising CeO₂ particles having a particle size of 0.6 μm (Hastilite Fin from Universal Photonics, Inc.). A second set of samples of Corning® Gorilla® Glass 7 were polished with a slurry comprising CeO₂ particles having a particle size of 1.2 μm (Super Cerite 415 from Gerard Kluyskens Co., Inc.).

The polished samples were cleaned with one of three aqueous solutions. The first aqueous solution comprised 0.1 wt. % HCl. The second aqueous solution comprised 0.1 wt. % HCl and 0.1 wt. % PDADMAC, and the third aqueous solution comprised 0.1 wt. % HCL and 1M KCl. Polished samples were contacted with the aqueous solution for a time of 2 minutes at 22° C. After a polished sample was contacted with one of the aqueous solutions, the polished sample was contacted with a 4 wt. % Semiclean solution for a time of 10 min. at a temperature of 60° C. with sonication. Some polished samples were not contacted with one of the three aqueous solutions. The optical properties of the cleaned samples were measured using an X-Rite spectrophotometer. The color shift of each of the cleaned samples is included in FIG. 2. It is contemplated that the color shift of the cleaned samples is primarily due to CeO₂ residue that was not removed from the surface of the glass samples.

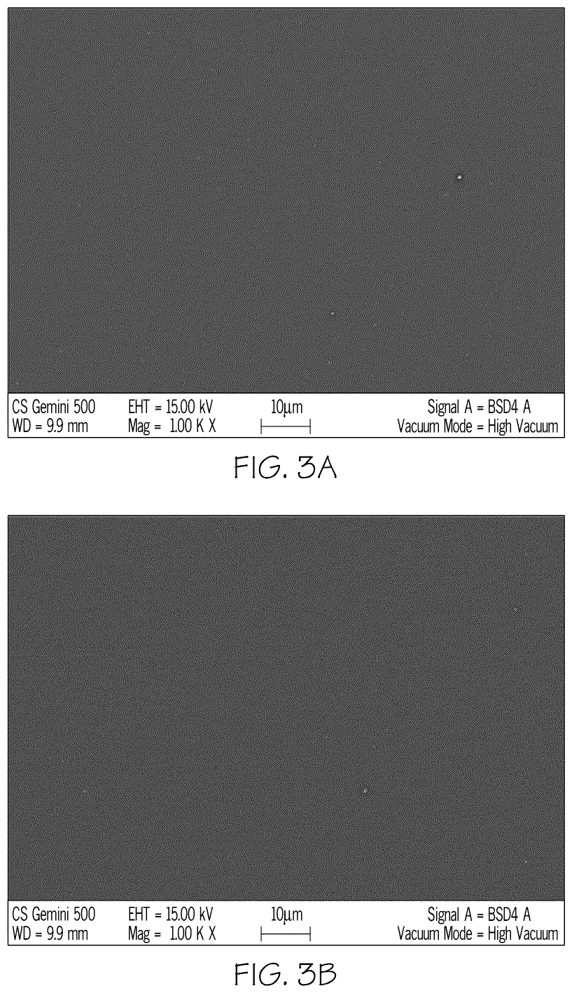

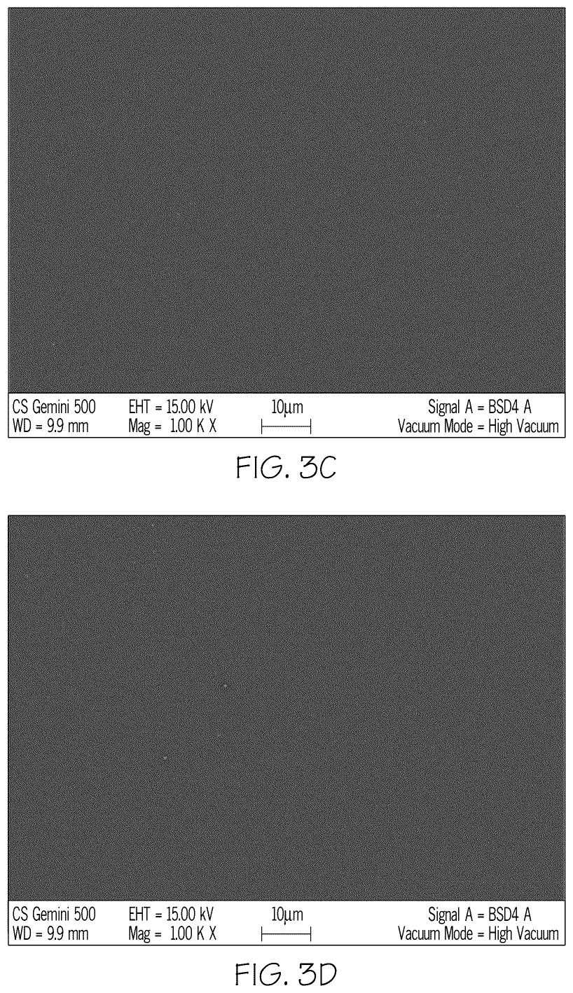

Scanning electron microscopy (SEM) images of the samples polished with the 1.2 μm CeO₂ particles are depicted in FIGS. 3A-3D. FIG. 3A depicts the surface of a polished sample that was not contacted with an aqueous solution or a Semiclean solution. FIG. 3B depicts the surface of a polished sample that was contacted with an aqueous solution comprising 0.1 wt. % HCl. FIG. 3C depicts the surface of a polished sample that was contacted with an aqueous solution comprising 0.1 wt. % HCl and 0.1 wt. % PDADMAC. FIG. 3D depicts the surface of a polished sample that was contacted with an aqueous solution comprising 0.1 wt. % HCl and 1 M KCl.

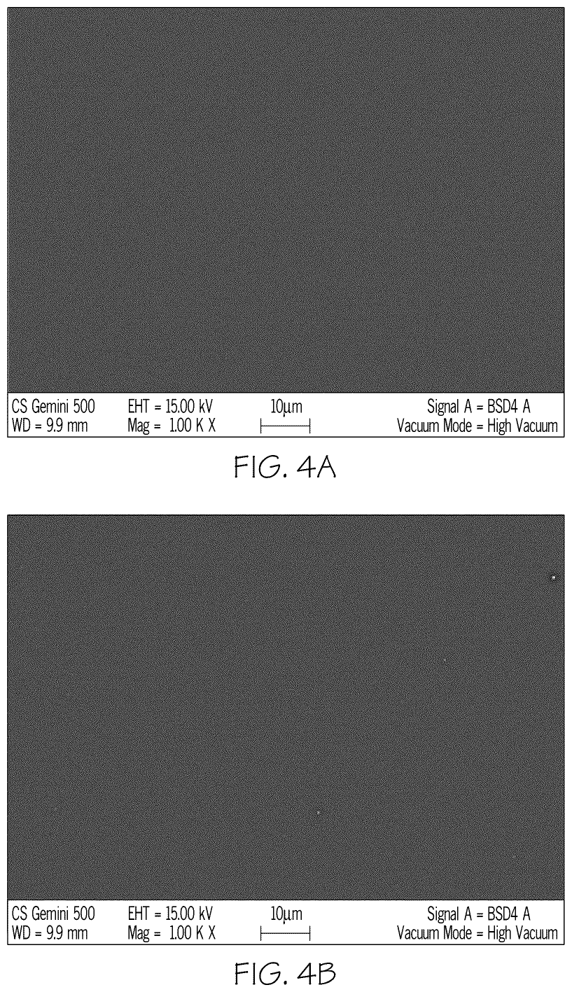

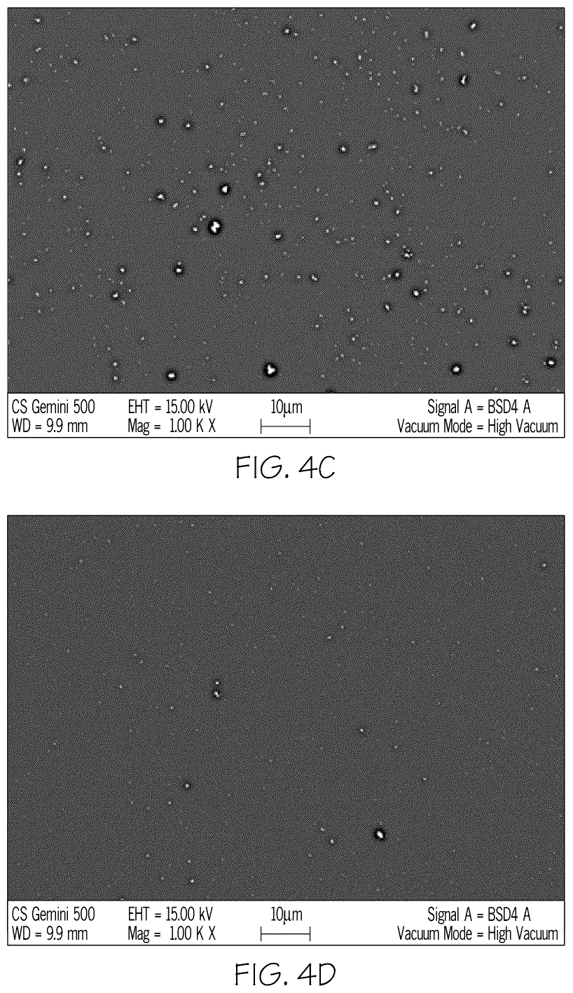

SEM images of the samples polished with the 0.6 μm CeO₂ particles are depicted in FIGS. 4A-4D. FIG. 4A depicts the surface of a polished sample that was not contacted with an aqueous solution or a Semiclean solution. FIG. 4B depicts the surface of a polished sample that was contacted with an aqueous solution comprising 0.1 wt. % HCl. FIG. 4C depicts the surface of a polished sample that was contacted with an aqueous solution comprising 0.1 wt. % HCl and 0.1 wt. % PDADMAC. FIG. 4D depicts the surface of a polished sample that was contacted with an aqueous solution comprising 0.1 wt. % HCl and 1 M KCl. As shown in FIGS. 3A-D and 4A-D, fewer particles were observed on the surfaces of the glass articles polished with 1.2 μm CeO₂ particles than on the surfaces of the glass articles polished with 0.6 μm CeO₂ particles.

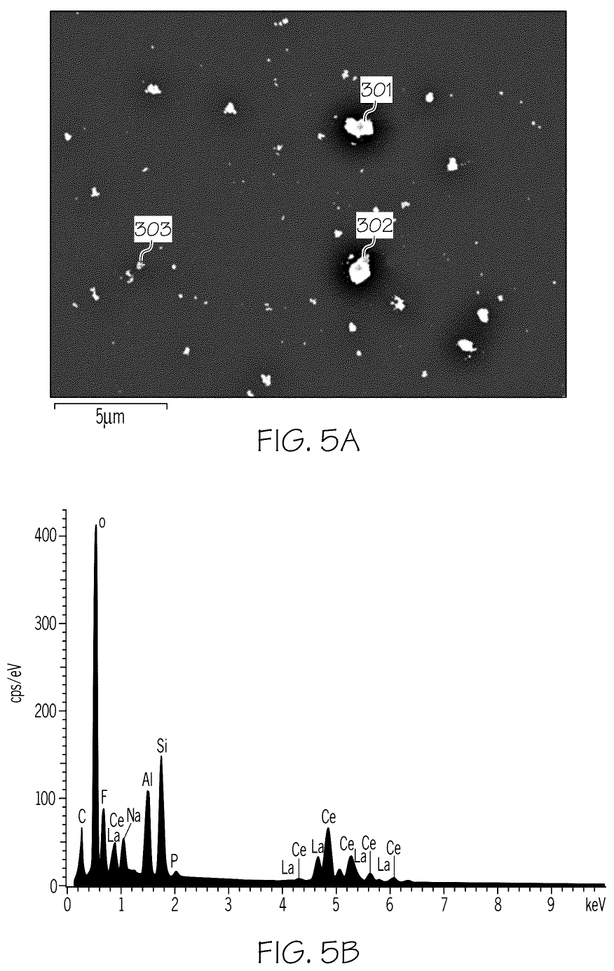

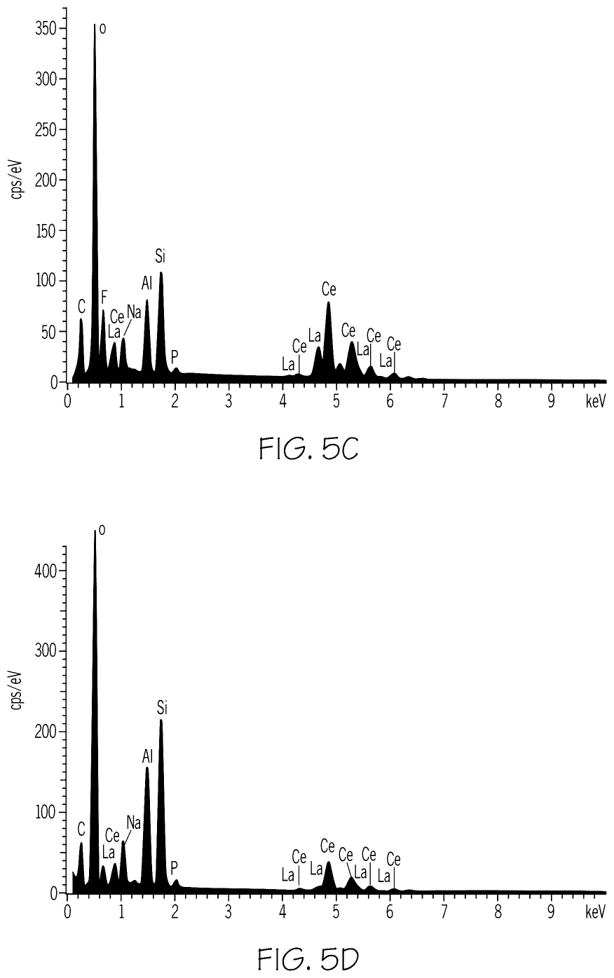

As depicted in FIG. 5A, particles were observed on the surface of the polished sample that was polished with CeO₂ having a particle size of 0.6 μm and was contacted with an aqueous solution comprising 0.1 wt. % HCl and 0.1 wt. % PDADMAC and a 4 wt. % semiclean solution, as previously described. Particles 301, 302, and 303 depicted in FIG. 5A were analyzed by energy-dispersive x-ray (EDX) spectroscopy. The EDX spectrum for particle 301 is depicted in FIG. 5B, the EDX spectrum for particle 302 is depicted in FIG. 5C, and the EDX spectrum for particle 303 is depicted in FIG. 5D. As shown in FIGS. 5B-5D, each particle was a CeO₂ particle.

The present disclosure is directed to various embodiments of aqueous solutions for cleaning glass articles and methods of using such aqueous solutions. In embodiments, an aqueous solution for cleaning a glass article may comprise water; at least one of hydrochloric acid, nitric acid, phosphoric acid, an organic acid, and combinations thereof; and a positively charged surfactant, and a metal salt. The aqueous solution may comprise from 0.01 wt. % to 1 wt. % of the positively charged surfactant based on the total weight of the aqueous solution. A concentration of the metal salt may be from 0.1 M to 1 M. Additionally, the aqueous solution may have a pH from 0 to 4.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. An aqueous solution for cleaning glass articles, the aqueous solution comprising:
water;
at least one of hydrochloric acid, nitric acid, phosphoric acid, an organic acid, and combinations thereof; and
at least one of:
a positively charged surfactant, wherein the aqueous solution comprises from 0.01 wt. % to 1 wt. % of the positively charged surfactant, based on a total weight of the aqueous solution; and
a metal salt, wherein a concentration of the metal salt is from 0.1 M to 1 M;
wherein the aqueous solution has a pH from 0 to 4.

2. The aqueous solution of claim 1, wherein the aqueous solution comprises the positively charged surfactant.

3. The aqueous solution of claim 2, wherein the positively charged surfactant comprises a quaternary ammonium cation.

4. The aqueous solution of claim 2, wherein the positively charged surfactant has a molecular weight from 10,000 Da to 400,000 Da.

5. The aqueous solution of claim 2, wherein the positively charged surfactant comprises an anion selected from Cl⁻ and Br⁻.

6. The aqueous solution of claim 2, wherein the positively charged surfactant comprises poly (diallyl dimethylammonium chloride), cetyltrimethylamonium bromide, or a combination thereof.

7. The aqueous solution of claim 1, wherein the aqueous solution comprises the metal salt.

8. The aqueous solution of claim 7, wherein the metal salt comprises a metal cation having a +1 charge.

9. The aqueous solution of claim 7, wherein the metal salt comprises LiCl, NaCl, CsCL, KCl, KNO₃, or a combination thereof.

10. The aqueous solution of claim 1, wherein the aqueous solution comprises an organic acid.

11. The aqueous solution of claim 10, wherein the organic acid comprises citric acid, acetic acid, oxalic acid, or combinations thereof.

12. The aqueous solution of claim 1, wherein the aqueous solution comprises from 3 wt. % to 0.03 wt. % hydrochloric acid.

13. The aqueous solution of claim 1, wherein the aqueous solution comprises from 0.1 wt. % to 5 wt. % citric acid.

14. The aqueous solution of claim 1, wherein a concentration of H₃O⁺ in the aqueous solution is from 0.0001 M to 1 M.

15. The aqueous solution of claim 1, wherein the pH of the aqueous solution is from 1 to 4.

16. A method for cleaning a glass article, the method comprising:
contacting the glass article with an aqueous solution to form a cleaned glass article, the aqueous solution comprising:
water;
at least one of hydrochloric acid, nitric acid, phosphoric acid, an organic acid, and combinations thereof; and
at least one of:
a positively charged surfactant, wherein the aqueous solution comprises from 0.01 wt. % to 1 wt. % of the positively charged surfactant, based on a total weight of the aqueous solution; and
a metal salt, wherein a concentration of the metal salt is from 0.1 M to 1 M;
wherein the aqueous solution has a pH from 0 to 4.

17. The method of claim 16, wherein contacting the glass article with the aqueous solution occurs at a temperature from 20° C. to 70° C.

18. The method of claim 16, wherein contacting the glass article with the aqueous solution occurs for a time from 0.5 min. to 30 min.

19. The method of claim 16, wherein the glass article comprises from 45 mol. % to 70 mol. % SiO₂, from 15 mol. % to 25 mol. % Al₂O₃, from 0 mol. % to 6 mol. % B₂O₃, from 0 mol. % to 5 mol. % P₂O₅, from 0 mol. % to 10 mol. % LiO₂, from 5 mol. % to 15 mol. % Na₂O, from 0 mol. % to 1 mol. % K₂O, from 0 mol. % to 5 mol. % MgO, from 0 mol. % to 1 mol. % TiO₂, and from 0 mol. % to 1 mol. % SnO₂.

20. The method of claim 16, wherein a color shift of the cleaned glass article is less than or equal to 1.

21. The method of claim 16, wherein a haze of the cleaned glass article is less than or equal to 0.03%.

22. The method of claim 16, wherein the method comprises an initial step of contacting the glass article with CeO₂ particles, wherein contacting the glass article with the CeO₂ particles polishes at least a portion of the glass article.

23. The method of claim 22, wherein the CeO₂ particles have a particle size from 0.6 μm to 3 μm.

24. The method of claim 22, wherein a surface of the cleaned glass article is substantially free from the CeO₂ particles.

25. The method of claim 16, wherein the method further comprises contacting the cleaned glass article with a basic solution, the basic solution having a pH from 10 to 14.

26. The method of claim 25, wherein the basic solution comprises KOH, NaOH, or combinations thereof.

27. The method of claim 25, wherein the cleaned glass article is contacted with the basic solution for a time from 2 min. to 12 min.
